(19) United States
(12) Patent Application Publication
(10) Pub. No.: US 2023/0400747 A1
(43) Pub. Date: Dec. 14, 2023

(54) INTELLIGENT REFLECTING DEVICE

(71) Applicant: Japan Display Inc., Tokyo (JP)

(72) Inventors: Shinichiro OKA, Tokyo (JP); Mitsutaka OKITA, Tokyo (JP); Daiichi SUZUKI, Tokyo (JP); Shigesumi ARAKI, Tokyo (JP)

(73) Assignee: Japan Display Inc., Tokyo (JP)

(21) Appl. No.: 18/451,122

(22) Filed: Aug. 17, 2023

Related U.S. Application Data
(63) Continuation of application No. PCT/JP2022/005131, filed on Feb. 9, 2022.

(30) Foreign Application Priority Data
Feb. 19, 2021 (JP) 2021-025383

(51) Int. Cl. G02F 1/313; G02F 1/00

(52) U.S. Cl. CPC G02F 1/313; G02F 1/0045; G02F 1/009; G02F 2201/121; G02F 2203/02

(57) ABSTRACT

According to one embodiment, an intelligent reflecting device includes a first substrate including a first base and a plurality of patch electrodes, a second substrate including a second base and a common electrode opposed to the plurality of patch electrodes, a liquid crystal layer held between the first and second substrates, a heat exchanger provided in contact with the second substrate, a temperature sensor, and a temperature controller that controls the heat exchanger based on the temperature detected by the temperature sensor, wherein an incident wave is incident on an incidence surface of the first substrate, and the heat exchanger is provided on a surface opposed to the incidence surface.

### CROSS-REFERENCE TO RELATED APPLICATIONS

This application is a Continuation Application of PCT Application No. PCT/JP2022/005131, filed Feb. 9, 2022 and based upon and claiming the benefit of priority from Japanese Patent Application No. 2021-025383 filed Feb. 19, 2021, the entire contents of all of which are incorporated herein by reference.

### FIELD

Embodiments described herein relate generally to an intelligent reflecting device.

### BACKGROUND

As a phase shifter used for a phased array antenna capable of electrically controlling directivity, a phase shifter using liquid crystal is developed. In the phased array antenna, a plurality of antenna elements to which a high-frequency signal is transmitted from a corresponding phase shifter are arranged one-dimensionally (or two-dimensionally). In the phased array antenna as described above, it is necessary to adjust the dielectric constant of the liquid crystal such that the phase difference between the high frequency signals input to the adjacent antenna elements becomes constant.

In addition, an intelligent reflecting device capable of controlling the reflection direction of a radio wave using liquid crystal similarly to a phased array antenna is also studied. In this intelligent reflecting device, reflection controller having reflecting electrodes are arranged one-dimensionally (or two-dimensionally). Also in the intelligent reflecting device, it is necessary to adjust the dielectric constant of the liquid crystal such that the phase difference of the reflected radio wave becomes constant between the adjacent reflection controllers.

The intelligent reflecting device is assumed to be installed outdoors. However, the temperature of the liquid crystal changes due to the temperature change outdoors, and the dielectric constant may deviate from a desired value.

### BRIEF DESCRIPTION OF THE DRAWINGS

FIG. 1 is a cross-sectional view showing an intelligent reflecting device according to the present embodiment.

FIG. 2 is a plan view showing the intelligent reflecting device shown in FIG. 1.

FIG. 3 is an enlarged plan view showing a patch electrode.

FIG. 4 is an enlarged cross-sectional view showing a part of the intelligent reflecting device.

FIG. 5 is a timing chart showing a change in voltages applied to the patch electrodes for each period in a method of driving the intelligent reflecting device according to the present embodiment.

FIG. 6 is a perspective view of the intelligent reflecting device according to the present embodiment.

FIG. 7 is a view showing the intelligent reflecting device according to the present embodiment.

FIG. 8 is a plan view showing a configuration example of an intelligent reflecting device according to the embodiment.

FIG. 9 is a partially enlarged cross-sectional view of the intelligent reflecting device.

### DETAILED DESCRIPTION

In general, according to one embodiment, an intelligent reflecting device comprises
a first substrate including a first base and a plurality of patch electrodes arranged in a matrix at regular intervals along a first direction and a second direction;
a second substrate including a second base and a common electrode opposed to the plurality of patch electrodes;
a liquid crystal layer held between the first substrate and the second substrate;
a heat exchanger provided in contact with the second substrate;
a temperature sensor that detects a temperature of the liquid crystal layer; and
a temperature controller that controls the heat exchanger based on the temperature detected by the
temperature sensor, wherein an incident wave is incident on an incidence surface of the first substrate, and
the heat exchanger is provided on a surface opposed to the incidence surface.

An object of the present embodiment is to provide an intelligent reflecting device in which a change in the dielectric constant is within a certain range even though an outside air temperature changes.

Embodiments will be described hereinafter with reference to the accompanying drawings. Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

The embodiments described herein are not general ones, but rather embodiments that illustrate the same or corresponding special technical features of the invention. The following is a detailed description of one embodiment of an intelligent reflecting device with reference to the drawings.

In this embodiment, a first direction X, a second direction Y and a third direction Z are orthogonal to each other, but may intersect at an angle other than 90°. The direction toward the tip of the arrow in the third direction Z is defined as up or above, and the direction opposite to the direction toward the tip of the arrow in the third direction Z is defined as down or below.

With such expressions as “the second member above the first member” and “the second member below the first member”, the second member may be in contact with the first member or may be located away from the first member. In the latter case, a third member may be interposed between the first member and the second member. On the other hand, with such expressions as “the second member on the first member” and “the second member beneath the first member”, the second member is in contact with the first member.

Further, it is assumed that there is an observation position to observe the intelligent reflecting device on a tip side of the arrow in the third direction Z. Here, viewing from this observation position toward the X-Y plane defined by the first direction X and the second direction Y is referred to as plan view. Viewing a cross-section of the intelligent reflecting device in the X-Z plane defined by the first direction X and the third direction Z or in the Y-Z plane defined by the second direction Y and the third direction Z is referred to as cross-sectional view.

### Embodiment

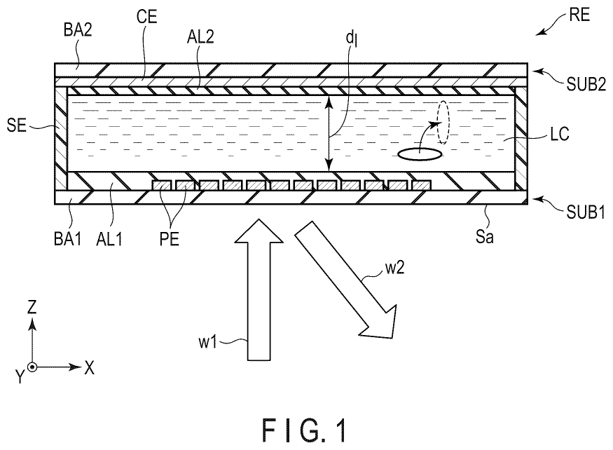

FIG. 1 is a cross-sectional view showing an intelligent reflecting device according to the present embodiment. An intelligent reflecting device RE can reflect radio waves and functions as a relay device for radio waves.

As shown in FIG. 1, the intelligent reflecting device RE includes a first substrate SUB1, a second substrate SUB2, and a liquid crystal layer LC. The first substrate SUB1 includes an electrically insulating base BA1, a plurality of patch electrodes PE, and an alignment film AL1. The base BA1 is formed in a flat plate shape and extends along an X-Y plane including a first direction X and a second direction Y orthogonal to each other. The alignment film AL1 covers the plurality of patch electrodes PE.

The second substrate SUB2 is disposed opposed to the first substrate SUB1 with a predetermined gap. The second substrate SUB2 includes an electrically insulating base BA2, a common electrode CE, and an alignment film AL2. The base BA2 is formed in a flat plate shape and extends along the X-Y plane. The common electrode CE is opposed to the plurality of patch electrodes PE in a direction parallel to a third direction Z orthogonal to the first direction X and the second direction Y. The alignment film AL2 covers the common electrode CE. In the present embodiment, the alignment film AL1 and the alignment film AL2 are a horizontal alignment film.

The first substrate SUB1 and the second substrate SUB2 are joined by a sealing member SE disposed in the peripheries. The liquid crystal layer LC is provided in a space surrounded by the first substrate SUB1, the second substrate SUB2, and the sealing member SE. The liquid crystal layer LC is held between the first substrate SUB1 and the second substrate SUB2. The liquid crystal layer LC is opposed to the plurality of patch electrodes PE on one side, and is opposed to the common electrode CE on the other side.

Here, the thickness (cell gap) of the liquid crystal layer LC is defined as a thickness dl. The thickness dl is larger than the thickness of the liquid crystal layer of a typical liquid crystal display panel, and is approximately 20 μm to 70 μm. In the present embodiment, the thickness dl is 50 μm. However, the thickness dl may be less than 50 μm as long as the reflection phase of the radio wave can be changed with a sufficient width. Alternatively, in order to increase the angle of reflection of the radio wave, the thickness dl may exceed 50 μm. A liquid crystal material used for the liquid crystal layer LC of the intelligent reflecting device RE is different from a liquid crystal material used for a typical liquid crystal display panel. Incidentally, the reflection phase of the radio wave will be described later.

To the common electrode CE, a common voltage is applied, and the electric potential of the common electrode CE is fixed. In the present embodiment, the common voltage is a ground voltage, for example, 0 V. A voltage is also applied to the patch electrode PE. In the present embodiment, the patch electrodes PE are AC driven. The liquid crystal layer LC is driven by a so-called longitudinal electric field. When the voltage applied between the patch electrode PE and the common electrode CE acts on the liquid crystal layer LC, the dielectric constant of the liquid crystal layer LC changes.

When the dielectric constant of the liquid crystal layer LC changes, the propagation velocity of the radio wave in the liquid crystal layer LC also changes. For this reason, the reflection phase of the radio wave can be adjusted by adjusting the voltage to act on the liquid crystal layer LC. As a result, it is possible to adjust the reflection direction of the radio wave.

In the present embodiment, the absolute value of the voltage acting on the liquid crystal layer LC is 10 V or less. This is because the dielectric constant of the liquid crystal layer LC is saturated at 10 V. However, the absolute value of the voltage acting on the liquid crystal layer LC may exceed 10 V. For example, when the improvement of the response speed of the liquid crystal is requested, a voltage exceeding 10 V may be applied to the liquid crystal layer LC at the initial stage of liquid crystal driving, and then a voltage of 10 V or less may be applied to the liquid crystal layer LC.

The first substrate SUB1 has an incidence surface Sa on a side opposed to a side opposed to the second substrate SUB2. Incidentally, in FIG. 1, an incident wave w1 is a radio wave incident on the intelligent reflecting device RE, and a reflected wave w2 is a radio wave reflected by the intelligent reflecting device RE.

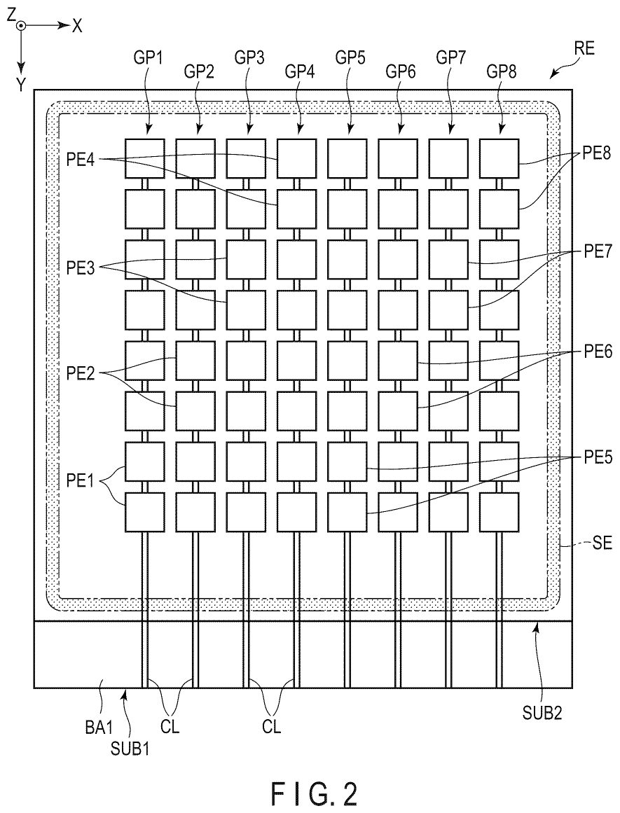

FIG. 2 is a plan view showing the intelligent reflecting device shown in FIG. 1. In the intelligent reflecting device RE shown in FIG. 2, the plurality of patch electrodes PE are arranged in a matrix at intervals along the first direction X and the second direction Y. In the X-Y plane, the plurality of patch electrodes PE have the same shape and the same size.

The plurality of patch electrodes PE are arranged at regular intervals along the first direction X and arranged at regular intervals along the second direction Y. The plurality of patch electrodes PE are included in a plurality of patch electrode groups GP extending along the second direction Y and arranged along the first direction X. In FIG. 2, the plurality of patch electrode groups GP include, for example, a first patch electrode group GP1 to an eighth patch electrode group GP8.

The first patch electrode group GP1 has a plurality of first patch electrodes PE1, the second patch electrode group GP2 has a plurality of second patch electrodes PE2, the third patch electrode group GP3 has a plurality of third patch electrodes PE3, the fourth patch electrode group GP4 has a plurality of fourth patch electrodes PE4, the fifth patch electrode group GP5 has a plurality of fifth patch electrodes PE5, the sixth patch electrode group GP6 has a plurality of sixth patch electrodes PE6, the seventh patch electrode group GP7 has a plurality of seventh patch electrodes PE7, and the eighth patch electrode group GP8 has a plurality of eighth patch electrodes PE8. For example, the second patch electrode PE2 is located between the first patch electrode PE1 and the third patch electrode PE3 in the direction along the first direction X.

The patch electrode groups GP each include a plurality of patch electrodes PE arranged along the second direction Y and electrically connected to each other. In the present embodiment, the plurality of patch electrodes PE of each of the patch electrode groups GP are electrically connected through connection lines CL. Incidentally, the first substrate SUB1 includes a plurality of connection lines CL extending along the second direction Y and arranged along the first direction X. The connection line CL extends to a region of the first substrate SUB1 that is not opposed to the second substrate SUB2. Incidentally, unlike the present embodiment, the plurality of connection lines CL may be connected to the plurality of patch electrodes PE in a one-to-one relationship.

In the present embodiment, the plurality of patch electrodes PE arranged along the second direction Y and the connection line CL are integrally formed of the same conductive material. Incidentally, the plurality of patch electrodes PE and the connection line CL may be formed of different conductive materials. The patch electrode PE, the connection line CL, and the common electrode CE are formed of a metal or a conductive material conforming to a metal. For example, the patch electrode PE, the connection line CL, and the common electrode CE may be formed of a transparent conductive material such as indium tin oxide (ITO). The connection line CL may be connected to a pad of outer lead bonding (OLB) (not shown).

The connection line CL is a wire, and the width of the connection line CL is sufficiently smaller than a length Px, described later. The width of the connection line CL is several μm to several tens μm, and is on the order of μm. Incidentally, when the width of the connection line CL is too large, a patch electrode group GP behaves as one rectangular electrode surface, and the sensitivity to the frequency component of the desired radio wave changes, which is undesirable.

The sealing member SE is disposed in a periphery of a region where the first substrate SUB1 and the second substrate SUB2 face each other.

FIG. 2 shows an example in which eight patch electrodes PE are arranged in the direction along the first direction X and the direction along the second direction Y. However, the present embodiment is not limited to this. The number of the patch electrodes PE can be variously modified. For example, 100 patch electrodes PE may be arranged in the direction along the first direction X, and a plurality of patch electrodes PE (for example, 100 patch electrodes PE) may be disposed in the direction along the second direction Y. The length of the intelligent reflecting device RE (first substrate SUB1) in the direction along the first direction X is, for example, 40 cm or more and 80 cm or less.

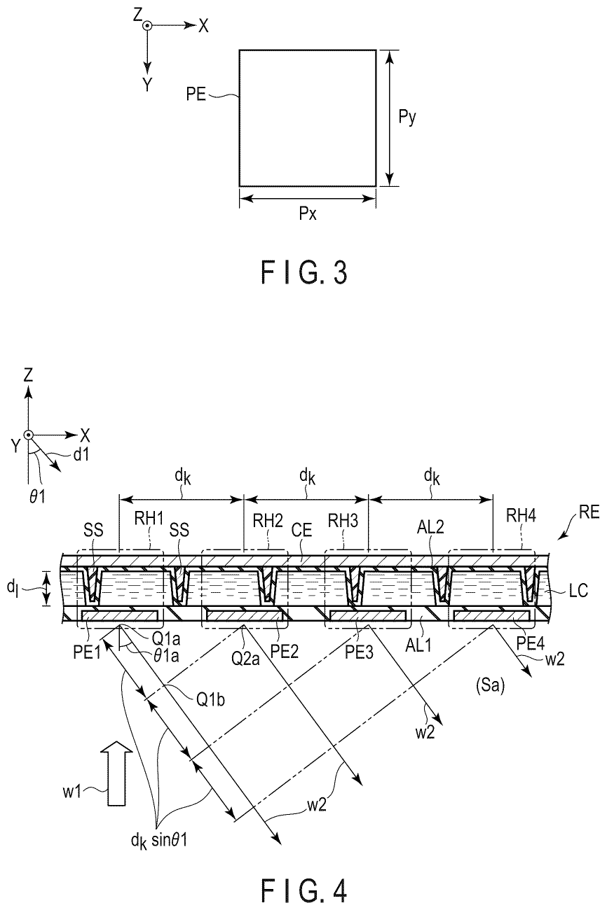

FIG. 3 is an enlarged plan view showing a patch electrode. As shown in FIG. 3, the patch electrode PE has a square shape. The shape of the patch electrode PE is not limited to the obtainment. However, the shape is desirably a square or a perfect circle. When attention is paid to the outer shape of the patch electrode PE, it is desirable to have a shape in which the aspect ratio is 1:1 in the vertical and horizontal directions. This is because a rotationally symmetric structure at an angle of 90° is desirable in order to cope with the transverse polarization and the vertical polarization.

The patch electrode PE has a length Px in a direction along the first direction X and a length Py in a direction along the second direction Y. The length Px and the length Py are desirably adjusted according to the frequency band of the incident wave w1. Next, a desirable relationship between the frequency band of the incident wave w1 and the lengths Px and Py will be exemplified.
2.4 GHz: Px=Py=35 mm
5.0 GHz: Px=Py=16.8 mm
28 GHz: Px=Py=3.0 mm

FIG. 4 is an enlarged cross-sectional view showing a part of the intelligent reflecting device. As shown in FIG. 4, the thickness dl (cell gap) of the liquid crystal layer LC is held by a plurality of spacers SS. In the present embodiment, the spacer SS is a columnar spacer, is formed on the second substrate SUB2, and protrudes toward the first substrate SUB1.

The width of the spacer SS is 10 μm or more and 20 μm or less. The length Px and the length Py of the patch electrode PE are on the order of mm, whereas the width of the spacer SS is on the order of μm. For this reason, the spacer SS has to be present in a region opposed to the patch electrode PE. In addition, the ratio of the region where the plurality of spacers SS exist in the region opposed to the patch electrode PE is approximately 1%. For this reason, even though the spacer SS exists in the region, the influence of the spacer SS on the reflected wave w2 is only a little. Incidentally, spacer SS may be formed on the first substrate SUB1 and protrude toward the second substrate SUB2. Alternatively, the spacer SS may be a spherical spacer.

The intelligent reflecting device RE includes a plurality of reflection controllers RH. Each of the reflection controllers RH includes one patch electrode PE of the plurality of patch electrodes PE, a part of the common electrode CE opposed to the one patch electrode PE, and a region of the liquid crystal layer LC opposed to the one patch electrode PE. Each of the reflection controllers RH functions to adjust the phase of the radio wave (incident wave w1) incident from the incidence surface Sa side according to the voltage applied to the patch electrode PE, and reflect the radio wave to the incidence surface Sa side to obtain the reflected wave w2. In each of the reflection controllers RH, the reflected wave w2 is a composite wave of the radio wave reflected by the patch electrode PE and the radio wave reflected by the common electrode CE.

The patch electrodes PE are arranged at regular intervals in the direction along the first direction X. The length (pitch) between the adjacent patch electrodes PE is defined as dk. The length dk corresponds to a distance from the geometric center of one patch electrode PE to the geometric center of the adjacent patch electrode PE. In the present embodiment, it is assumed that the reflected waves w2 have the same phase in the first reflection direction dl. In the X-Z plane of FIG. 4, the first reflection direction dl is a direction forming a first angle θ1 with the third direction Z. The first reflection direction dl is parallel to the X-Z plane. In FIG. 4, θ1a is equal to θ1 (θ1=θ1a).

In order to align the phases of the radio waves reflected by the plurality of reflection controllers RH in the first reflection direction dl, it is sufficient that the phases of the radio waves are aligned on a straight two-dot chain line. For example, it is sufficient that the phase of the reflected wave w2 at a point Q1b and the phase of the reflected wave w2 at a point Q2a are aligned. A physical linear dimension from the point Q1a to the point Q1b of the first patch electrode PE1 is dk×sin θ1. For this reason, focusing on the first reflection controller RH1 and the second reflection controller RH2, the phase of the reflected wave w2 from the second reflection controller RH2 only has to be delayed from the phase of the reflected wave w2 from the first reflection controller RH1 by a phase amount 51. Here, the phase amount δ1 is expressed by the following formula.

δ1=dk×sin θ1×2Π/λ

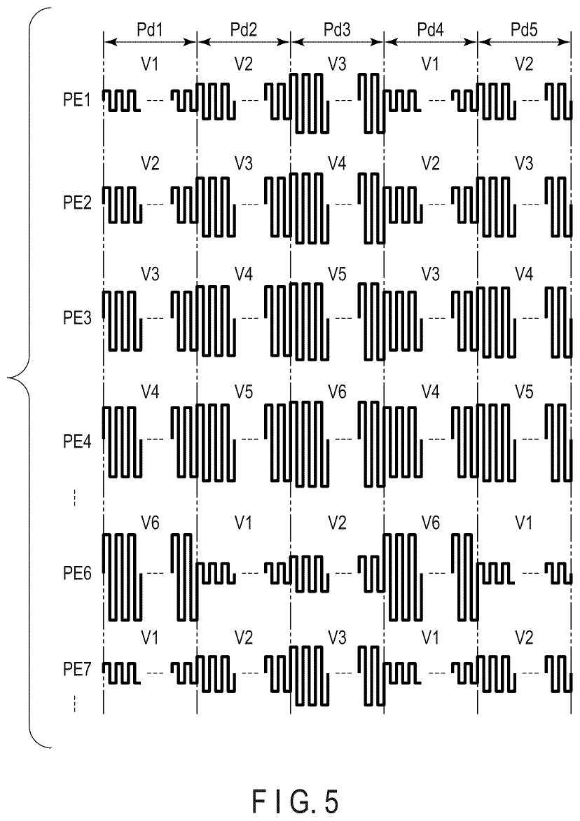

FIG. 5 is a timing chart showing a change in voltages applied to the patch electrodes for each period in a method of driving the intelligent reflecting device according to the present embodiment. FIG. 5 shows a first period Pd1 to a fifth period Pd5 in the driving period of the intelligent reflecting device RE.

As shown in FIGS. 4 and 5, when the driving of the intelligent reflecting device RE is started, in the first period Pd1, the voltage V is applied to the plurality of patch electrodes PE such that the radio waves reflected by the plurality of reflection controllers RH have the same phase in the first reflection direction dl. For example, a first voltage V1 is applied to the first patch electrode PE1, a second voltage V2 is applied to the second patch electrode PE2, and a third voltage V3 is applied to the third patch electrode PE3.

During a second period Pd2 following the first period Pd1, a voltage is applied to the plurality of patch electrodes PE such that the radio waves reflected by the plurality of reflection controllers RH are held in the same phase in the first reflection direction dl. For example, the second voltage V2 is applied to the first patch electrode PE1, the third voltage V3 is applied to the second patch electrode, and the fourth voltage V4 is applied to the third patch electrode PE3.

In each period Pd, the same voltage is applied to the plurality of patch electrodes PE of each patch electrode group GP through the connection line CL.

In each of the first period Pd1 and the second period Pd2, the polarity of the voltage applied to each of the patch electrodes PE is periodically inverted when the electric potential of the common electrode CE is a reference. For example, the patch electrodes PE are driven at a driving frequency of 60 Hz. Since the patch electrode PE is AC driven, a fixed voltage is not applied to the liquid crystal layer LC for a long period of time. Since the occurrence of burning can be suppressed, it is possible to suppress the deviation of the direction of the reflected wave w2 from the first reflection direction dl.

Furthermore, in the present embodiment, in each of the patch electrodes PE, the absolute value of the voltage applied in the second period Pd2 is different from the absolute value of the voltage applied in the first period Pd1. Since the occurrence of burning can be sufficiently suppressed, it is possible to suppress the deviation of the direction of the reflected wave w2 from the first reflection direction dl.

Even though the period Pd is changed to another period Pd, the phase amount 51 of the radio wave reflected in the first reflection direction dl by one reflection controller RH and the radio wave reflected in the first reflection direction dl by the adjacent reflection controller RH is maintained. In the present embodiment, the phase amount 51 is at an angle of 60°.

In the example illustrated in FIG. 5, the sixth voltage V6 is applied to the sixth patch electrode PE6 in the first period Pd1. A phase difference at an angle of 300° is given between the radio wave reflected in the first reflection direction dl by the first reflection controller RH1 and the radio wave reflected in the first reflection direction dl by the sixth reflection controller including the sixth patch electrode PE6.

In order to provide a phase difference at an angle of 360° between the radio wave reflected in the first reflection direction dl by the first reflection controller RH1 and the radio wave reflected in the first reflection direction dl by the seventh reflection controller including the seventh patch electrode PE7, the seventh voltage may be applied to the seventh patch electrode PE7 in the first period Pd1. However, in the present embodiment, the first voltage V1 is applied to the seventh patch electrode PE7 in the first period Pd1. By the periodic voltage application pattern, it is possible to drive a large number of patch electrodes PE while reducing types of the voltage V.

Here, a case where the above-described intelligent reflecting device RE is installed outdoors will be considered. The dielectric constant of the liquid crystal layer LC included in the intelligent reflecting device RE depends on the temperature. The dielectric constant of the liquid crystal depends on the temperature even in a high frequency band, for example, 28 GHz as described above. The absolute value of the dielectric constant is significant for the phase control of the intelligent reflecting device RE. A change in the dielectric constant due to a temperature change may cause an error in phase modulation.

The liquid crystal according to the present embodiment has dielectric anisotropy, and the dielectric constant of the liquid crystal at a phase transition temperature or lower is a dielectric constant ε⊥ in a direction perpendicular to the liquid crystal director and a dielectric constant ε// in a direction parallel to this. Above the phase transition temperature, the liquid crystal exhibits isotropy and has only a single dielectric constant. Near the phase transition temperature, the change in dielectric constant of the liquid crystal is steep. In contrast, in the case of a temperature away from the phase transition temperature, the change in the dielectric constant of the liquid crystal is gentle.

As described above, the absolute value ε(=|ε//−ε⊥|) of the difference between the dielectric constant ε⊥ and the dielectric constants ε// is significant for phase control of the intelligent reflecting device RE. In the phase control of the intelligent reflecting device RE, ε⊥, more preferably, ε//, and Δε are constant.

When the intelligent reflecting device RE is installed outdoors, the temperature exceeds the phase transition temperature due to an increase in the outside air temperature, and this may cause the transition of the liquid crystal to isotropy. In addition, even though the temperature does not exceed the phase transition temperature, the change in dielectric constant becomes steep near the phase transition temperature, and there is a possibility that an error in phase modulation increases.

When the outside air temperature drops, a drop in the temperature of the liquid crystal may increase the viscosity of the liquid crystal increases, and the quality of the intelligent reflecting device RE may be degraded.

As described above, the liquid crystal has temperature dependence on the dielectric anisotropy. The intelligent reflecting device according to the present embodiment utilizes dielectric anisotropy, and the dielectric constant ε⊥ and the dielectric constant ε// are designed to have optimum values. However, when the dielectric constant largely deviates from the optimum value due to the outside air temperature, the intelligent reflecting device according to the present embodiment may not be optimally driven. Therefore, it is necessary to maintain the intelligent reflecting device according to the present embodiment at an optimum temperature so as not to largely deviate from the dielectric anisotropy at the time of design.

Therefore, in the present embodiment, the heat exchanger and the temperature sensor are provided on the intelligent reflecting device to stop a temperature change of the intelligent reflecting device, and thus the absolute value of the dielectric constant is controlled. As a result, it is possible to suppress an error in phase modulation in the intelligent reflecting device. In the intelligent reflecting device according to the present embodiment, it is possible to perform optimum driving based on the designed dielectric anisotropy.

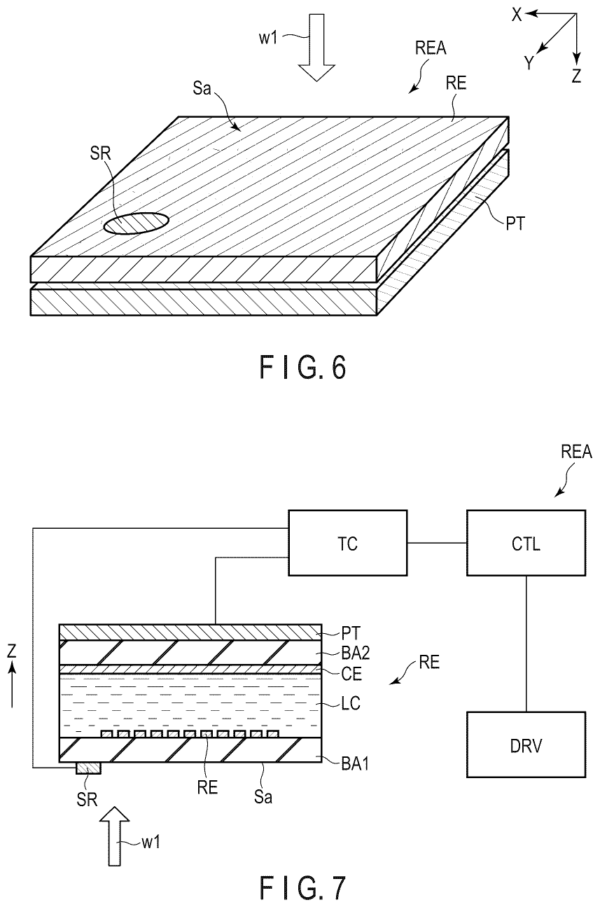

FIG. 6 is a perspective view of the intelligent reflecting device according to the present embodiment. An intelligent reflecting device REA shown in FIG. 6 includes the intelligent reflecting device RE described in FIGS. 1 to 5, a heat exchanger PT, and a temperature sensor SR. The heat exchanger PT is, for example, a Peltier element. The Peltier element is an element capable of controlling a surface on one side to a heat generating state or a heat absorbing state depending on a direction of a direct current to flow.

When the intelligent reflecting device RE has a high temperature due to the outside air temperature, the intelligent reflecting device RE can be cooled by the Peltier element. Conversely, when the intelligent reflecting device RE has a low temperature, the intelligent reflecting device RE can be heated by the Peltier element. However, the heat exchanger PT is not limited to the Peltier element, and other heat exchangers may be used. As another heat exchanger, for example, a heat exchanger having a cooling function by air cooling or water cooling and having a heating function may be used.

Although not shown in FIG. 6, a radiator plate may be provided in contact with the heat exchanger PT.

The temperature sensor SR detects the temperature of the intelligent reflecting device RE, particularly the liquid crystal layer LC. The heat exchanger PT is controlled based on the detected temperature. In the intelligent reflecting device REA shown in FIG. 6, the temperature sensor SR is provided outside the intelligent reflecting device RE. However, the temperature sensor SR may be built in the intelligent reflecting device RE. The temperature sensor SR is preferably provided at a position closer to the liquid crystal layer LC. When the temperature sensor SR is provided outside the intelligent reflecting device RE, the temperature sensor SR only has to be provided in contact with the first substrate SUB1 or the second substrate SUB2.

FIG. 7 is a diagram showing the intelligent reflecting device according to the present embodiment. The intelligent reflecting device REA shown in FIG. 7 includes the intelligent reflecting device RE, the temperature sensor SR, the heat exchanger PT, a temperature controller TC, a drive circuit DRV, and a controller CTL. The intelligent reflecting device RE has the same configuration as described above. However, only some components are shown in FIG. 7 in order to make the drawing easy to see. The temperature sensor SR and the heat exchanger PT are similar to those in FIG. 6.

The temperature controller TC controls the heat exchanger PT based on the temperature of the intelligent reflecting device RE detected by the temperature sensor SR.

The drive circuit DRV drives the patch electrode PE and the common electrode CE.

The controller CTL controls the drive circuit DRV and the temperature controller CT based on an input from the outside.

When the temperature sensor SR detects that the outside air temperature rises in the environment where the intelligent reflecting device REA is placed, the temperature of the liquid crystal layer LC rises, and in particular, the temperature is around the phase transition temperature, the temperature controller CT outputs a control signal to the heat exchanger PT. The heat exchanger PT cools the intelligent reflecting device RE based on the control signal. By cooling the intelligent reflecting device RE, the liquid crystal layer LC can be maintained at a temperature equal to or lower than the phase transition temperature.

Since the dielectric constant of the liquid crystal layer LC is steep near the phase transition temperature, fine temperature control is desirable. When the temperature of the liquid crystal layer LC is away from the vicinity of the phase transition temperature, the dielectric constant of the liquid crystal layer LC is gentle, and thus fine temperature control is not necessary as compared with the case described above.

When the temperature of the liquid crystal layer LC is far from the vicinity of the phase transition temperature (for example, 50° C. or higher), for example, the temperature of the heat exchanger PT only has to be controlled such that the liquid crystal layer LC is ±30° C., preferably approximately ±20° C.

Alternatively, the temperature of the heat exchanger PT only has to be controlled such that 0c, which is a change in the dielectric constant of the liquid crystal layer LC, is within ±20%, preferably within ±10%.

When the outside air temperature drops in the environment where the intelligent reflecting device REA is placed and the temperature of the liquid crystal layer LC drops, the temperature controller CT outputs a control signal to the heat exchanger PT. The heat exchanger PT heats the intelligent reflecting device RE based on the control signal. As a result, it is possible to increase the temperature of the liquid crystal layer LC and stop an increase in the viscosity of the liquid crystal.

In FIGS. 6 and 7, the heat exchanger PT is provided on the surface of the intelligent reflecting device RE opposed to the incidence surface Sa (also referred to as a reflective surface) of the incident wave w1. As a result, the incidence of the incident wave w1 on the intelligent reflecting device RE and the reflection of the reflected wave w2 are not hindered.

Specifically, the heat exchanger PT is provided in contact with the base BA2 of the second substrate SUB2. Incidentally, in the present embodiment, the base BA1 and the base BA2 are also referred to as a first base and a second base, respectively.

The temperature sensor SR may be provided on the incidence surface Sa or on a surface opposed to the incidence surface Sa. Specifically, the heat exchanger PT may be provided in contact with the base BA1 of the first substrate SUB1.

According to the present embodiment, it is possible to obtain an intelligent reflecting device in which a change in the dielectric constant is within a certain range even though an outside air temperature changes.

### Configuration Example 1

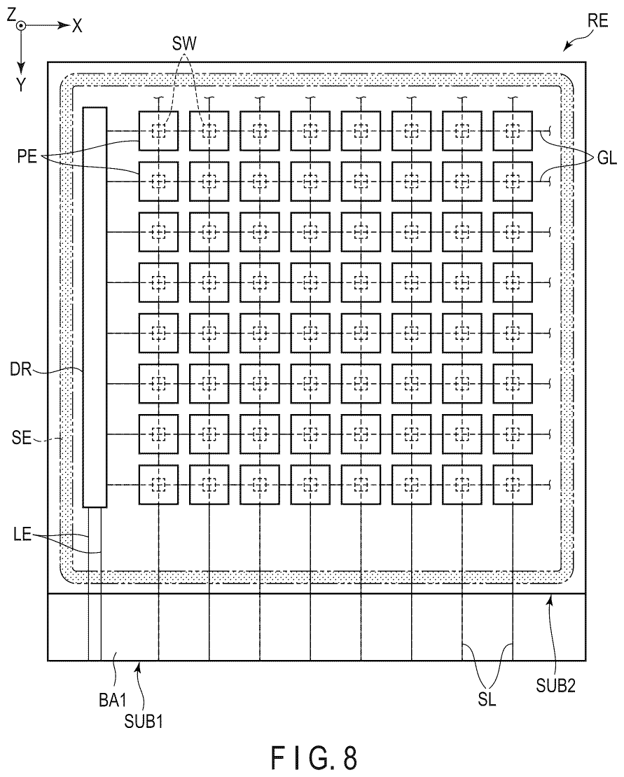

FIG. 8 is a plan view showing a configuration example of the intelligent reflecting device according to the embodiment. The configuration example illustrated in FIG. 8 is different from the embodiment shown in FIG. 2 in that the patch electrodes are driven by active matrix driving.

FIG. 8 is a plan view of an intelligent reflecting device RE according to the present configuration example.

As shown in FIG. 8, a first substrate SUB1 includes a plurality of signal lines SL, a plurality of control lines GL, a plurality of switching elements SW, drive circuit DR, and a plurality of lead wires LE instead of connection line CL.

The plurality of signal lines SL extend along the second direction Y and are disposed in a direction along the first direction X. The plurality of control lines GL extend along the first direction X and is disposed in a direction along the second direction Y. The plurality of control lines GL are connected to the drive circuit DR. The switching element SW is provided near an intersection between one signal line SL and one control line GL. The plurality of lead wires LE are connected to the drive circuit DR. The signal line SL and the lead wire LE may be connected to a pad of outer lead bonding (OLB).

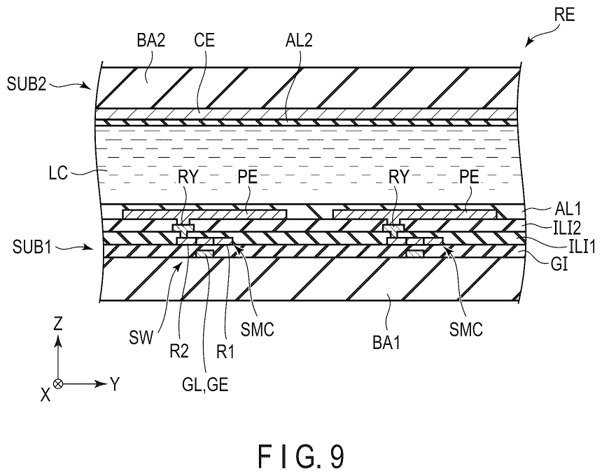

FIG. 9 is a partially enlarged cross-sectional view of the intelligent reflecting device. As shown in FIG. 9, the control line GL is provided on the base BA1 of the intelligent reflecting device RE. The control line GL includes a gate electrode GE. On the base BA1 and the control line GL, an insulating layer GI is formed. On the insulating layer GI, a semiconductor layer SMC is provided. The semiconductor layer SMC overlaps on the gate electrode GE and has a first region R1 and a second region R2. In the first region R1 and the second region R2, one is a source region and the other is a drain region.

The gate electrode GE, the semiconductor layer SMC, and the like constitute a switching element SW as a thin-film transistor (TFT). The switching element SW may be a bottom-gate thin-film transistor or a top-gate thin-film transistor.

On the insulating layer GI and the semiconductor layer SMC, an insulating layer ILI1 is formed. On the insulating layer ILI1, a connection electrode RY and a signal line SL are provided. Although not illustrated in the drawing, the signal line SL is connected to the first region R1 of the semiconductor layer SMC. The connection electrode RY passes a contact hole formed in the insulating layer ILI1, and is connected to the second region R2 of the semiconductor layer SMC.

On the insulating layer ILI1, the signal line SL, and the connection electrode RY, an insulating layer ILI2 is formed. On the insulating layer ILI2, a patch electrode PE is formed. The patch electrode PE passes a contact hole formed in the insulating layer ILI2, and is connected to the connection electrode RY. On the insulating layer ILI2 and the patch electrode PE, an alignment film AL1 is formed.

As shown in FIGS. 8 and 9, the plurality of patch electrodes PE can be individually driven by active matrix driving. For this reason, the plurality of patch electrodes PE can be independently driven. For example, the direction of the reflected wave w2 reflected by the intelligent reflecting device RE can be a direction parallel to the Y-Z plane.

The present configuration example exerts the same effect as that of the embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An intelligent reflecting device comprising:
a first substrate including a first base and a plurality of patch electrodes arranged in a matrix at regular intervals along a first direction and a second direction;
a second substrate including a second base and a common electrode opposed to the plurality of patch electrodes;
a liquid crystal layer held between the first substrate and the second substrate;
a heat exchanger provided in contact with the second substrate;
a temperature sensor that detects a temperature of the liquid crystal layer; and
a temperature controller that controls the heat exchanger based on the temperature detected by the temperature sensor, wherein
an incident wave is incident on an incidence surface of the first substrate, and
the heat exchanger is provided on a surface opposed to the incidence surface.

2. The intelligent reflecting device according to claim 1, wherein
the heat exchanger is a Peltier element.

3. The intelligent reflecting device according to claim 1, further comprising:
a plurality of connection lines arranged along the first direction and extending along the second direction, wherein
the plurality of patch electrodes extend along the second direction and form a plurality of patch electrode groups arranged along the first direction, and
the plurality of patch electrodes of each of the patch electrode groups are electrically connected through the connection lines.

4. The intelligent reflecting device according to claim 1, wherein
each of the plurality of patch electrodes is connected to a switching element.

5. The intelligent reflecting device according to claim 1, wherein
the temperature sensor is provided in contact with the first substrate or the second substrate.

6. The intelligent reflecting device according to claim 1, wherein
the temperature sensor is built in the intelligent reflecting device.

7. The intelligent reflecting device according to claim 1, wherein
the temperature controller controls the heat exchanger such that a temperature of the liquid crystal layer is ±30° C.

8. The intelligent reflecting device according to claim 1, wherein
the temperature controller is configured to control the heat exchanger such that a temperature of the liquid crystal layer is ±20° C.

9. The intelligent reflecting device according to claim 1, wherein
the temperature controller is configured to control the heat exchanger such that a change in a dielectric constant of the liquid crystal layer is within ±20%.

10. The intelligent reflecting device according to claim 1, wherein
the temperature controller is configured to control the heat exchanger such that a change in a dielectric constant of the liquid crystal layer is within ±10%.

11. The intelligent reflecting device according to claim 1, wherein
the temperature controller is configured to control the heat exchanger so as to maintain the liquid crystal layer at a temperature equal to or lower than a phase transition temperature.
